(19) United States
(12) Patent Application Publication
(10) Pub. No.: US 2003/0184560 A1
(43) Pub. Date: Oct. 2, 2003

(54) Display system for increasing legibility of small electronic device displays

(76) Inventor: James W. Pierce, Cedar Park, TX (US)

Correspondence Address: PITTS AND BRITTIAN P C, P O BOX 51295, KNOXVILLE, TN, 37950-1295, US

(21) Appl. No.: 10/377,539

(22) Filed: Feb. 28, 2003

Related U.S. Application Data
(60) Provisional application No. 60/367,978, filed on Mar. 27, 2002.

(51) Int. Cl. G09G 5/02

(52) U.S. Cl. 345/605; 345/589

(57) ABSTRACT

Described is a display system for increasing the legibility of the space limited text displays of small electronic devices. The display system couples the existing Rapid Sequential Visualization Presentation (RSVP) technology with a mathematically calculated color scheme to indicate the position of a sequentially presented word relative to the complete sentence that comprises the word.

### CROSS-REFERENCE TO RELATED APPLICATIONS

This application claims the benefit of U.S. Provisional Application No. 60/367,978, filed Mar. 27, 2002.

### STATEMENT REGARDING FEDERALLY SPONSORED RESEARCH OR DEVELOPMENT

Not Applicable

### BACKGROUND OF THE INVENTION

1. Field of Invention

This invention pertains to a display system for increasing the legibility of the space limited text displays of small electronic devices. More particularly, this invention pertains to a display system for indicating the position of a word within its respective sentence in order to increase the comprehensiveness of Rapid Sequential Visualization Presentation.

2. Description of the Related Art

Technology has introduced mobile devices such as Personal Digital Assistants, Pocket PC's, and cellular phones to everyday life. Technology has also decreased the size of these devices to the extent that they fit into a coat pocket. Subsequently, the text displays of these devices are very limited in size. With limited area allocated for the display of text, a single sentence becomes too small to comfortably read and an entire document is virtually unapproachable. Further, devices presenting text transferred at real-time lose their real-time feature to the slow tedious task of reading the undersized text.

Rapid Sequential Visualization Presentation (RSVP) has taken a step in resolving the aforementioned issue. RSVP technology presents a sentence piecemeal by words in sequential order, beginning with the first word of a given sentence and ending with the last word of the sentence. Therefore, instead of a particular text display area presenting several lines of text, the display area presents one large intelligible word. This technology not only increases the size of the presented text, military studies have revealed this technology to increase a reading rate of 150 words-per-minute to over 1000 words-per-minute. While this technology does present larger text, it is limited in that it does not reveal the position of the displayed word relative to its complete sentence, thus leaving the meaning of the word with a handicapping degree of ambiguity.

### BRIEF SUMMARY OF THE INVENTION

In accordance with the various features of the present invention there is provided a display system for increasing the legibility of the space limited text displays of small electronic devices. The display system couples the existing Rapid Sequential Visualization Presentation (RSVP) technology with a mathematically calculated color scheme to indicate the position of a sequentially presented word relative to the complete sentence that comprises the word. With knowledge of the position of each given word within its respective sentence, a reader achieves full comprehension of the sentence without requiring the presentation of the sentence as a line of text.

The display system comprises a text frame and a position indicator frame. The text frame presents a textual data stream by way of RSVP, while the position indicator frame presents the discussed calculated color scheme. The position indicator frame is positioned proximate to the text frame such that the user is conscious of the position indicator frame as the text is read. Therefore, the user understands the structure of a sentence as the sentence is presented one word at a time.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 depicts a display system illustrating the various features of the present invention;

FIG. 2 is a flow diagram illustrating the operation of the display system of FIG. 1;

FIG. 3 is a flow diagram illustrating the calculation of a color scheme in accordance with the various features of the present invention;

FIG. 4 is a diagram illustrating a component of the calculation illustrated in FIG. 3; and

FIG. 5 is a block diagram representing the electrical operation of a possible embodiment of a display system as a stand alone display.

### DETAILED DESCRIPTION OF THE INVENTION

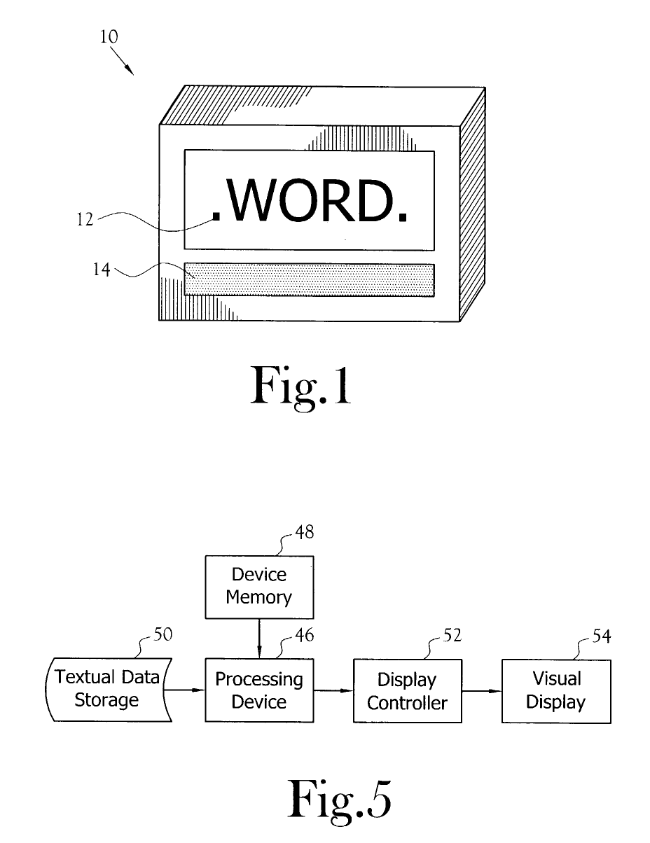

One embodiment of a display system for increasing the legibility of the space limited text displays of small electronic devices and constructed in accordance with the various features of the present invention is illustrated generally at 10 in FIG. 1. The display system 10 couples the existing Rapid Sequential Visualization Presentation (RSVP) technology with a mathematically calculated color scheme to indicate the position of a sequentially presented word relative to the complete sentence that comprises the word. With knowledge of the position of each given word within its respective sentence, a reader achieves full comprehension of the sentence without requiring the presentation of the sentence as a line of text.

FIG. 1 illustrates a display system 10 constructed in accordance with the various features of the present invention. In the illustrated embodiment, the display system 10 is depicted as a stand-alone display in order to focus on the various features of the present invention. Those skilled in the art will recognize that the display system 10 may be integrated into an existing display of an electronic device without interfering with the scope or spirit of the present invention. The display system 10 comprises a text frame 12 and a position indicator frame 14. The text frame 12 presents text in a RSVP manner, which presents a sentence piecemeal by words in sequential order, beginning with the first word of a given sentence and ending with the last word of the sentence.

The position indicator frame 14 is positioned proximate to the text frame 12, and in the illustrated embodiment, is a rectangular bar positioned directly below the text frame 12. Those skilled in the art will recognize that the shape, size, and position of the position indicator frame 14 may vary without interfering with the scope or spirit of the present invention. In the illustrated embodiment, the position indicator frame 14 varies in color relative to the sentence position of the word presented in the text frame 12. For example, when the text frame 12 presents the first word of a sentence, the position indicator frame 14 reveals a first color, and when the text frame 12 presents the last word of the sentence, the position indicator frame 14 reveals a second color. As the sentence progresses from the first word to the last word, the position indicator frame 14 gradually progresses from the first color to the second color correspondingly.

For a document comprised of multiple sentences, the position indicator frame 14 reinitiates its color progression with the first word of each sentence. Additionally, for a document comprised of multiple paragraphs, the position indicator frame 14 reveals a designated color that is distinguishable from the colors associated with word position to indicate a new paragraph. In one embodiment, the position indicator frame 14 reveals a black or white flash to indicate a new paragraph. Once the flash has occurred, the position indicator frame 14 resumes its color progression for the sentences of the new paragraph.

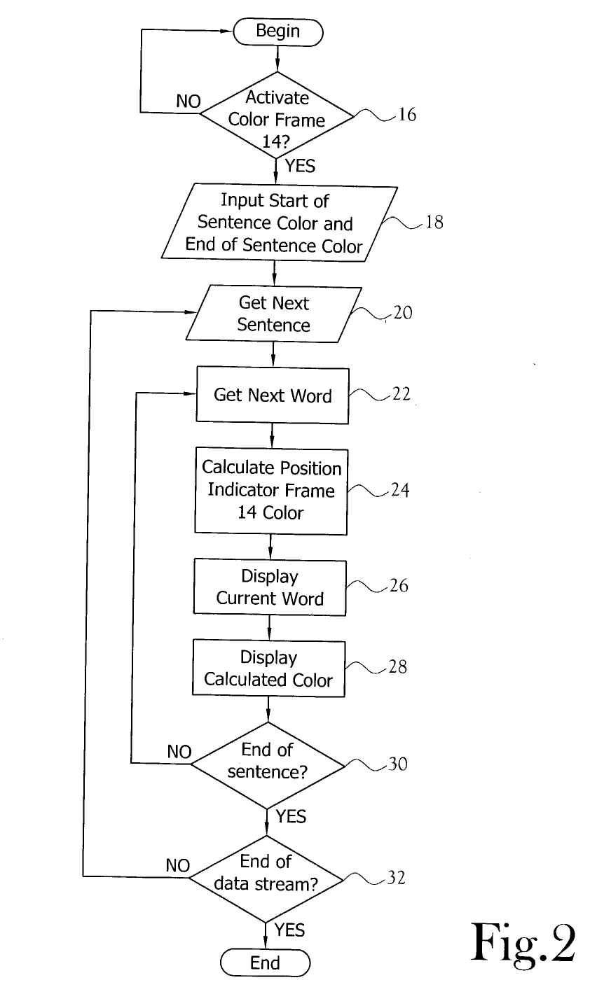

FIG. 2 is a flow diagram illustrating a program that governs the operation of the display system 10 of FIG. 1. According to the flow diagram, when the program begins, the user decides whether or not to activate the position indicator frame 14 at block 16. If the position indicator frame 14 is activated, the user enters the desired sentence starting color and sentence ending color at block 18. Then, at block 20, the program reads and stores the first or next sentence of the incoming data stream as the current sentence. Similarly, at block 22, the program reads and stores the first or next word of the current sentence as the current word. Considering the position of the current word within the current sentence, the program mathematically calculates a color that coincides with the position of the current word at block 24. The program then presents the current word in the text frame 12, at block 26, and presents the calculated color in the position indicator frame 14 at block 28. After displaying the current information, the program determines whether the current word is the last word of the current sentence at block 30. If the current word is not the last word of the current sentence, the program returns to the Get Next Word block 22. If the current word is the last word of the current sentence, the program proceeds to block 32, whereupon, the program determines whether the current sentence is the last sentence of the data stream. If the current sentence is not the last sentence of the data stream, the program returns to the Get Next Sentence block 20. If the current sentence is the last word of the current data stream, the program is terminated.

Those skilled in art will recognize that a program varying from the specific flow diagram illustrated and discussed in FIG. 2 may be used without interfering with the scope or spirit of the present invention.

FIG. 3 is a block diagram illustrating a program for calculating the color of the position indicator frame 14 as depicted at block 24 of FIG. 2. In the illustrated embodiment and for the purpose of this example, the position indicator frame 14 operates in an 8-bit color mode and changes from red to green along with the example sentence: “The boy is tall”. Therefore, at block 32, a variable X is assigned the value of zero, and a variable Y is assigned the value of a pre-calculated variable Z.

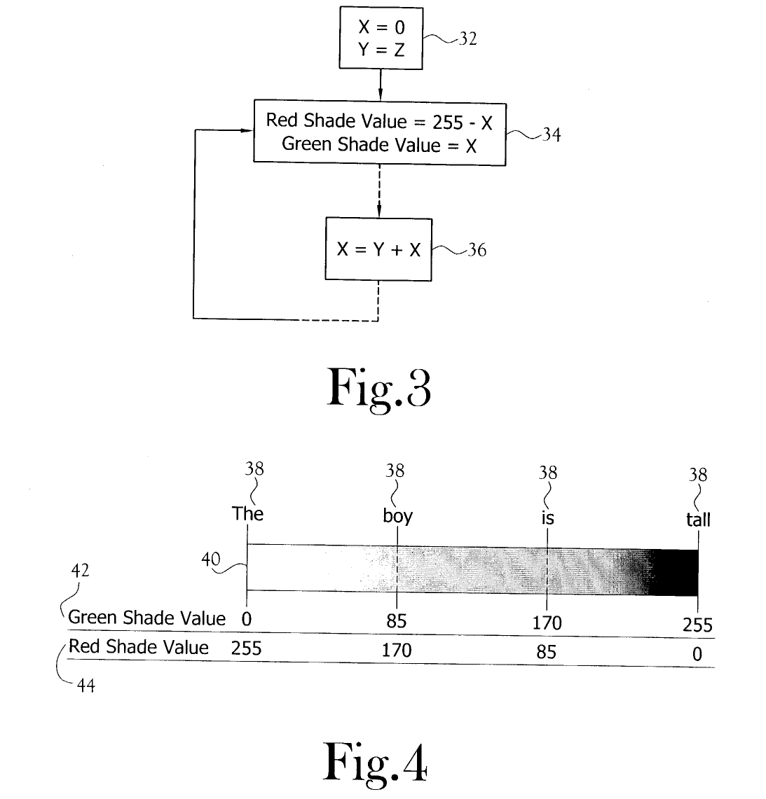

The determination of the value Z is illustrated in the diagram of FIG. 4. In the illustrated embodiment, each word of the example sentence 38 is positioned above a color scale 40 at the color that is presented in the position indicator frame 14 at the time the respective word is presented in the text frame 12. The corresponding color is more specifically indicated by a green shade value 42 and a red shade value 44 positioned directly below each word. Because an 8-bit color mode is utilized, red shade values 44 and green shade values 42 range from 0 to 255, which is 2\hat{ }8 shades for each color. Therefore, when “The” is presented in the text frame 12, the green shade value 42 is 0 and the red shade value 44 is 255, consequently, the position indicator frame 14 presents the color red. Likewise, when “tall” is presented in the text frame 12, the green shade value 42 is 255 and the red shade value 44 is 0, therefore, the position indicator frame 14 presents the color green. Because the shade values must change in consistent increments in order to reveal a uniform change from red to green, the illustrated diagram shows that as each word of the example sentence is sequentially presented, the green shade value 42 increases by a value of 85 and the red shade value 44 decreases by a value of 85, thus presenting a consistent and gradual change from red to green in accordance with the progression of the sentence. The shade value of each increment or decrement is the value of Z. Therefore, in the illustrated embodiment, the value of Z is 85. Mathematically, Z is the ratio of the maximum shade value to the number of increments required by the current sentence.

Those skilled in the art will recognize that it is not necessary for the position indicator frame 14 to progress from red to green in accordance with progression of a sentence. The position indicator frame 14 can progress from green to red in accordance with a sentence without interfering with the scope or spirit of the present invention. Additionally, those skilled in the art will recognize that the position indicator frame 14 can utilize any distinguishable colors to indicate the progression of a sentence.

At block 34 of FIG. 3, the red shade value is assigned a value of 255 (which is the maximum shade value)−X and the green shade value is assigned the value of X. Then, as indicated at block 26 and block 28 of FIG. 2, the current word and current combination of green shade and red shade are presented in the text frame 12 and the position indicator frame 14 respectively. Finally, at block 36, X is assigned the value of Y+X. When the program loops back to block 34, the red shade value has a decreased value relative to the previous calculation and the green shade value has an increased value relative to the previous calculation. Therefore, with each loop of the program, the presented color will gradually shift from red to green in accordance with each presented word.

Those skilled in the art will recognize that a flow diagram varying from the specific flow diagram of FIG. 3 may be used without interfering with scope or spirit of the present invention. Additionally, those skilled in the art will recognize that the bit color mode and the colors discussed in the example of FIG. 4 may vary without interfering with the scope or spirit of the present invention.

FIG. 5 is a block diagram illustrating the electrical operation of one embodiment of the display system 10 in accordance with the various features of the present invention. A processing device 46 for executing the program discussed in FIG. 2 is in electrical communication with a device memory 48, which is utilized for the general operation of the display system 10. The processing device 46 reads the data stream to be displayed from a textual data storage 50 and forwards the processed data to a display controller 52 that transfers the processed data to a visual display 54, which presents the data stream as described in FIG. 1. It is understood that because the illustrated embodiment represents a standalone display system 10, the textual data storage 50 acquires the textual data stream from a corresponding electronic device.

From the foregoing description, those skilled in the art will recognize that a system for displaying text within a limited display area offering advantages over the prior art has been provided. The system provides a position indicator that reveals the position of a RSVP presented word with respect to its comprising sentence, thus revealing the sentence structure of the comprising sentence allowing the sentence to be fully comprehended without presenting the sentence as lines of text.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A display system for increasing the legibility of text presented on the space limited displays of small electrical devices by indicating the position of a word displayed by Rapid Sequential Visualization Presentation within its respective sentence, said system comprising:
a text frame; and
a position indicator frame positioned proximate to said text frame;
whereby said text frame utilizes Rapid Sequential Visualization Presentation and said position indicator frame indicates the position of a presented word with respect to its comprising sentence.

2. The system of claim 1 wherein said position indicator frame employs a color scheme to indicate the position of a presented word within its respective sentence.

3. The system of claim 2 wherein said position indicator frame gradually changes from a first color to a second color in accordance with the progression of a sentence.

4. The system of claim 1 wherein said position indicator frame presents a color distinguishable from the colors associated with word position to indicate the presentation of a new paragraph.

5. A display system for increasing the legibility of text presented on the space limited displays of small electrical devices by indicating the position of a word displayed by Rapid Sequential Visualization Presentation within its respective sentence, said system comprising:
a means for presenting text by way of Rapid Sequential Visualization Presentation; and
a means for indicating the sentence position of a word presented by said means for presenting text.

6. The system of claim 5 wherein means for indicating the sentence position of a word comprises the utilization of a color scheme.

7. A display system for increasing the legibility of text presented on the space limited displays of small electrical devices by indicating the position of a word displayed by Rapid Sequential Visualization Presentation within its respective sentence, said system comprising:
a housing;
a text frame mounted within said housing; and
a position indicator frame mounted within said housing, said position indicator frame positioned proximate to said text frame;
whereby said text frame utilizes Rapid Sequential Visualization Presentation and said position indicator frame indicates the position of a presented word with respect to its comprising sentence.

8. The system of claim 7 wherein said position indicator frame employs a color scheme to indicate the position of a presented word within its respective sentence.

9. The system of claim 8 wherein said position indicator frame gradually changes from a first color to a second color in accordance with the progression of a sentence.

10. The system of claim 7 wherein said position indicator frame presents a color distinguishable from the colors associated with word position to indicate the presentation of a new paragraph.
